(19) United States
(12) Patent Application Publication
(10) Pub. No.: US 2026/0203015 A1
(43) Pub. Date: Jul. 16, 2026

(54) COMPUTER IMPLEMENTED SYSTEMS AND METHODS OF ADDITION AND SUBTRACTION OF NUMBERS REPRESENTED IN A LOGARITHMIC NUMBER SYSTEM

(71) Applicant: LEMURIAN LABS INC., Oakville (CA)

(72) Inventor: Vassil DIMITROV, Calgary (CA)

(73) Assignee: LEMURIAN LABS INC., Oakville (CA)

(21) Appl. No.: 19/560,514

(22) Filed: Mar. 9, 2026

Related U.S. Application Data
(63) Continuation of application No. PCT/IB2024/058704, filed on Sep. 6, 2024.
(60) Provisional application No. 63/581,289, filed on Sep. 8, 2023.

(51) Int. Cl. G06F 7/483; G06F 7/485

(52) U.S. Cl. CPC G06F 7/4833; G06F 7/485

(57) ABSTRACT

A computer-implemented method of addition of real numbers represented in a parallel adaptive logarithmic number system (PALNS) includes representing two positive real numbers x and y in a PALNS, as follows: x=(B1\hat{ }a)*(B2\hat{ }b), y=(B1\hat{ }c)*(B2\hat{ }d), wherein B1 and B2 are bases, and wherein y≥x, and a, b, c and d are positive integer exponents. A value R=Log_{B1}B2 is calculated. A value of R is approximated as R1/R2. R1 and R2 are positive integers and R1≥R2. A discriminator K is calculated as (R2*(c−a)+R1*(d−b). An approximation of 1+B1\hat{ }(K/R2) is determined as (B1\hat{ }g(K))*(B2\hat{ }h(K)) for a plurality of integers of K, wherein g(K) and h(K) are restricted to integers as a function of the value of K. The sum of x+y is approximated for every integer K, as: x+y≈B1\hat{ }(a+g(K))*B2\hat{ }(b+h(K))=(B1\hat{ }e(K))*(B2\hat{ }f(K)), wherein e(K)=a+g(K) and f(K)=b+h(K).

### CROSS REFERENCE TO RELATED APPLICATIONS

This application is a bypass continuation application under 35 U.S.C. § 111 (a) of International Application PCT/IB2024/058704, filed Sep. 6, 2024, and published as WO 2025/052320 A1 on Mar. 13, 2025. PCT/IB2024/058704 claims priority from U.S. provisional application 63/581,289, filed Sep. 8, 2023. The entire contents each of these prior applications are hereby incorporated herein by reference.

### TECHNICAL FIELD

The present disclosure relates to computer implemented systems and methods of representation and manipulation of data represented in a logarithmic number system. More specifically, the disclosure relates to systems and methods of computer implemented addition and subtraction of numbers represented in a parallel adaptive logarithmic number system (PALNS).

### BACKGROUND

The popularity of logarithmic number systems (LNS) for data representation and manipulation continues to grow. As a computer implemented data representation scheme, logarithmic number systems have been successfully used to encode and manipulate numerical data in various applications, such as, for example, digital signal processing applications.

The main purpose of the logarithmic encoding is to convert binary data (such as fixed point or floating point binary data) to the logarithmic domain, where multiplication processes are transformed into simpler, faster and less memory intensive addition processes. Other fundamental data operations, such as division and square roots, are also substantially simplified over a conventional binary data representation system. For example, division operations are transformed into subtraction operations and square root processes are transformed into a bit-shift operation. Table 1 below outlines some of those advantageous features.

TABLE 1

| Operation floating | | Implementation of the |
|---|---|---|
| or fixed- | Transformation into | operation in logarithmic |
| point domain | logarithmic domain | domain |
| x*y | log(x*y) | log(x) + log(y) |
| x/y | log(x/y) | log(x) − log(y) |
| sqrt(x) | log(sqrt(x)) | ½ log(x) |

Problematically however, within prior art logarithmic data representation systems, the fundamental arithmetic operations of addition and subtraction become more difficult, time consuming and require more memory capacity than conventional binary data systems.

Accordingly, there is a need for computer implemented logarithmic data representation systems and methods that simplify addition and subtraction operations. There is also a need to reduce the amount of memory storage required for the implementation of addition and subtraction operations in a logarithmic data representation system or method.

### BRIEF DESCRIPTION

The present disclosure offers advantages and alternatives over the prior art by providing novel systems and methods of addition and subtraction of two real numbers x and y represented in a parallel adaptive logarithmic number system (PALNS). The methods and system significantly reduce the amount of memory required to perform additions and subtractions in the logarithmic domain.

A computer-implemented method of addition of real numbers represented in a parallel adaptive logarithmic number system (PALNS), in accordance with aspects described herein, includes representing two positive real numbers x and y in a PALNS, as follows:
x=(B1\hat{ }a)*(B2\hat{ }b), y=(B1\hat{ }c)*(B2\hat{ }d), wherein B1 and B2 are bases, and wherein y≥x, and a, b, c and d are positive integer exponents. A value R=Log_{B1}B2 is calculated. A value of R is approximated as R1/R2. R1 and R2 are positive integers and R1≥R2. A discriminator K is calculated as (R2*(c−a)+R1*(d−b)). An approximation of 1+B1\hat{ }(K/R2) is determined as (B1\hat{ }g(K))*(B2\hat{ }h(K)) for a plurality of integers of K, wherein g(K) and h(K) are restricted to integers as a function of the value of K. The sum of x+y is approximate for every integer K, as: x+y≈B1\hat{ }(a+g(K))*B2\hat{ }(b+h(K))=(B1\hat{ }e(K))*(B2\hat{ }f(K)), wherein e(K)=a+g(K) and f(K)=b+h(K).

The addition method may be implemented in a computer system, which includes a memory and one or more processors in electronic communication with the memory. An algorithm may be stored in the memory as a set of instructions for execution by the one or more processors. The algorithm may be programmed to perform the method.

The addition method may also be stored in a computer program product. The computer program product may include at least one non-transitory computer readable storage medium. The storage medium may store instructions, for execution by a processor, to perform the method.

A computer-implemented method of subtraction of real numbers represented in a parallel adaptive logarithmic number system (PALNS), in accordance with aspects described herein, includes representing two positive real numbers x and y in a PALNS, as follows: x=(B1\hat{ }a)*(B2\hat{ }b), y=(B1\hat{ }c)*(B2\hat{ }d), wherein B1 and B2 are bases, and wherein x≥y, and a, b, c and d are positive integer exponents. A value of R is calculated as Log_{B1}B2. R is approximated as R≈R1/R2, wherein R1 and R2 are positive integers and R1≥R2. A discriminator K is designated as K=(R2*(a−c)+R1*(b−d). The best approximation of B1\hat{ }(K/R2)−1 as (B1\hat{ }g(K))*(B2\hat{ }h(K)) is determined for every integer of a plurality of integers of K, wherein g(K) and h(K) are restricted to integers as a function of the value of K. The result of x−y is approximated, for every integer of the plurality of integers of K, as: x−y≈B1\hat{ }(c+g(K))*B2\hat{ }(d+h(K))=(B1\hat{ }e(K))*(B2\hat{ }f(K)) wherein e(K)=c+g(K) and f(K)=d+h(K).

The subtraction method may be implemented in a computer system, which includes a memory and one or more processors in electronic communication with the memory. An algorithm may be stored in the memory as a set of instructions for execution by the one or more processors. The algorithm may be programmed to perform the method.

The subtraction method may also be stored in a computer program product. The computer program product may include at least one non-transitory computer readable storage medium. The storage medium may store instructions, for execution by a processor, to perform the method.

### BRIEF DESCRIPTION OF THE DRAWINGS

The disclosure will be more fully understood from the following detailed description taken in conjunction with the accompanying drawings, in which:

FIG. 1, depicts an example of a computer-implemented method of addition of real numbers represented in a parallel adaptive logarithmic number system (PALNS) according to aspects described herein;

FIG. 2, depicts an example of a computer-implemented method of subtraction of real numbers represented in a parallel adaptive logarithmic number system (PALNS) according to aspects described herein; and

FIG. 3 depicts an example of a computing environment useable to perform the methods of FIG. 1 and FIG. 2, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

### General Overview

### Logarithmic Number Systems (LNS)

For addition and/or subtraction operations performed on real numbers (e.g., x, y) represented in a logarithmic number systems (LNS), it is helpful, if not essential, to find a suitable expansion formula for log(x+y), in order to make the hardware implementation of such operations practical. One such well known expansion is as follows:

$$log ( x + y ) = log ( x * ( 1 + y / x ) ) = log ( x ) + log ( 1 + y / x )$$

Various approaches have been suggested to approximate the function f(z)=log(1+z). Those include piece-wise linear approximations, polynomial approximations, the use of reduced-addressed look-up tables, and more. However, all of the previous methods and systems used to approximate the above function require a large amount of memory resources to accommodate, for example, large look-up tables (LUT), and/or complex hardware solutions. Further such previous methods and systems consume a significant amount of time, memory and power.

Since x and y are encoded in logarithmic format, it is appropriate to re-write the above formula as follows:

$$Log ( x + y ) = log ( {2}^{∧} a + {2}^{∧} b ) = log ( {2}^{∧} a * ( 1 + {2}^{∧} ( b - a ) ) = a + log ( 1 + {2}^{∧} ( b - a ) )$$

where x=(2\hat{ }a), y=(2\hat{ }b) and the symbol: \hat{ } represents raising the base 2 to a power of an exponent (e.g., exponents a or b), and the log is to the base of 2.

Note that the examples provided herein are shown as logarithms to the base 2. However, any base or bases may be used. For example, the bases of the logarithms represented herein may be 2, 3, 10, e (i.e., base of the natural log function, which substantially equals 2.718281828459), 1.618 (the positive root of x\hat{ }2−x−1=0), 1.927 (the positive root of x\hat{ }4−x\hat{ }3−x\hat{ }2−x−1=0) and more.

### Parallel Adaptive Logarithmic (PAL) Number Systems (PALNS)

A general definition, used herein, for a parallel adaptive logarithmic number system (PALNS), sometimes referred to as multidimensional logarithmic number systems (MDLNS), representation of a real number may be defined as follows:

A real number “x” is equal to, or approximated by, the summation of digits from i equals 1 to d total number of digits. Wherein each digit is equal to plus or minus 1 multiplied by a product over a set of bases Bj raised to an exponent aj from j equals 1 to k total number of bases.

The representation can be represented mathematically by the following formula I:

$$x = {\sum }_{i = 1}^{d} s ( i ) {\prod }_{j = 1}^{k} Bj \hat{} aj$$

Where each “digit” equals the sign s (i) multiplied by the expression:

$${\prod }_{j = 1}^{k} Bj \hat{} aj$$

Where the symbol Π represents a product over a set of the terms Bj\hat{ }aj. The symbol \hat{ } represents raising the base Bj of each term to the power of the exponent aj of the term.

The sign s (i) of each digit is equal to plus or minus 1, the total number of digits is d, the total number of bases Bj per digit is k, and the exponents the bases are raised to are aj. Advantageously, as will be discussed in greater detail herein, in the PALNS representations of numbers disclosed herein, the exponents, aj that each of the bases Bj are raised to may all be non-negative integers, which may significantly reduce the amount of storage space required to store a real number in a computer's memory.

In applications and examples of PALNS used herein, one or two digits are used. However, there may be any number of digits used in a PALNS.

For purposes of clarity, the following examples of 1-digit and 2-digit PALNS representations are provided:

### Example I

The number 100 may be written several different ways in a 2-digit, 2-base PALNS format as follows:

$$\begin{matrix}A . & 100 = + {2}^{5} {3}^{1} + {2}^{2} {3}^{0} , \\ B . & 100 = + {2}^{6} {3}^{0} + {2}^{2} {3}^{2} , \\ C . & 100 = + {2}^{2} {3}^{3} - {2}^{3} {3}^{0} .\end{matrix}$$

The above examples are error-free representations of the number 100 in 2-digit PALNS with bases (2,3), wherein d=2, k=2, B1=2, B2-3 and the signs are showcased directly in the description.

### Example II

The number 100 may also be written several different ways in a single digit (1-digit), 2-base PALNS format. However, in the case of bases (2,3), the number 100 must be approximated into the form 2\hat{ }a*3\hat{ }b. Such an approximation can be achieved with any prescribed precision if we increase the sizes of the exponents. In the case of 100, a very good approximation is 2-52337, which is equal to 99.9831199.

Numbers of a PALNS are often encoded as a vector of its exponents. So, in the case of the 1-digit, 2-base PALNS (Example II): 100 may be approximated as (1,−52, 37), wherein the first component is the sign and the second and third components are the exponents that the bases 2 and 3 are raised to respectively. In the case of the 2-digit PALNS (Example I): 100 may be exactly represented as follows:
Example I. A: (1,5,1,1,2,0),
Example I. B: (1,6,0,1,2,2), and
Example I. C: (1,2,3,−1,3,0)

Wherein the first and the fourth components are signs, the second and third components are the exponents that the bases 2 and 3 are raised to respectively for the first digit, and the fifth and sixth components are the exponents that the bases 2 and 3 are raised to respectively for the second digit.

It is important to note that 1-digit representations are computationally simpler and lead to simplified architectures than that of 2-digit representations. On the other hand, the use of 2-digit representations allow extremely good accuracy with significantly smaller exponents compared to 1-digit representations.

It is also important to note that using two or more bases to represent a number, provides a user with a degree of control of the sign of the exponents associated with each base. This is because the number represented is the product of two terms (a base raised to a power of an exponent), and there are any number of term values that can be multiplied together to obtain or approximate the number represented. For example, in the case of single digit, two base (2, 3) PALNS representing the number 100. The number 100 may be approximated as:
100≈2⁻⁵²3³⁷=99.9831199, wherein the base 2 exponent is negative and the base 3 exponent is positive; or
100≈2¹³3⁻⁴=101.13, wherein the base 2 exponent is positive and the base 3 exponent is negative.

### Comparison Between Classical LNS and PLANS

Classical logarithmic number systems (LNS) can be viewed as a special case of a PALNS wherein a) there is only one digit; b) there is only one base and c) the exponents can be defined as real (fixed or floating point numbers).

In both number systems—LNS and PALNS—the multiplication procedure is converted into addition; the division is converted into subtraction and the square root is converted into bit shifts. Table 2 below provides a comparison of some of the main operations in both LNS and PALNS:

TABLE 2
Conceptual complexity comparison of different
operations in logarithmic-based number systems

| Arithmetic | | |
|---|---|---|
| operation in | | |
| logarithmic | | |
| representations | Difficulty | |
| (LNS and PALNS) | level | Implementation |
| Square root, inversion | The easiest | 1-bit shift to the right (for |
| | | square root implementation); |
| | | change of the sign bit (for |
| | | inversion implementation) |
| Multiplication, Division | Easy | Addition (for multiplication |
| | | implementation); Subtraction |
| | | (for division implementation) |
| Addition, Subtraction | Most difficult | Both operations are converted |
| | | into additions/subtractions |
| | | and look-up table operations |

The above Table 2 showcases the similarities between LNS and PALNS. The main differences are in the details associated with the specific implementation of the arithmetic operations. Table 3 below provides a summary of some of those differences:

TABLE 3
Comparison between LNS and PALNS

| | Implementation in LNS | Implementation in PALNS | Winner |
|---|---|---|---|
| Inversion | Change of the sign | Change of sign | Tie |
| Square root | Bit-shift | Bit-shift and conditional | LNS |
| | | addition | |
| Multiplication | n-bit adders | n/2-bit adders | PALNS |
| Division | n-bit adders | n/2-bit adders | PALNS |
| Add/Sub | n-bit adders and LUT of | n/2-bit adders and LUT of size | PALNS |
| | size 2ⁿ | 2^{n/2} | |

### Logarithmic Number System Addition/Subtraction-Main Issues

As outlined previously the basics of addition in a logarithmic number system (LNS) involve the conversion of Log (x+y), which in the case of the log to the base 2 system, can be rewritten as:

$$2 \hat{} a + 2 \hat{} b = 2 \hat{} a * ( 1 + 2 \hat{} ( b - a ) ) \approx 2 \hat{} a * 2 \hat{} z = 2 \hat{} ( a + z ) , wherein x = 2 \hat{} a and y = 2 \hat{} b and 2 \hat{} z \approx ( 1 + 2 \hat{} ( b - a ) ) .$$

The most problematic and time-consuming part of the above conversion is the implementation of the transformation of 1+2\hat{ }(b−a) to 2\hat{ }z, which is typically implemented with a look-up table containing the precomputed values of the function f(y)≈1+2\hat{ }y in logarithmic format. It is the large size of those LUTs that prevents the use of logarithmic number systems in much broader spectrum of applications. All the variables used in this transformation a, b, x, y may be floating point numbers.

Additionally, all the variables used in this transformation a, b, x, y may be floating point numbers. The need to designate a decimal point for every variable may take up a considerable amount of memory capacity.

### Improved PALSN Addition/Subtraction Algorithms

The following algorithms for addition and subtraction provide advantages and improvements over the above described main issue and other issues related to addition and subtraction in the logarithmic domain. The novel algorithms provided herein for addition and subtraction have substantially the same basic structure. As an overview, each algorithm starts with the computation of a discriminator (referred to herein as “K”). The discriminator K may be a non-negative integer that represents a comparison of the relative magnitudes of the two real numbers x, y to be added or subtracted. This is important because if the ratio of the real numbers y/x is known, or reasonably accurately approximated, then rules can be determined wherein the addition or subtraction of the numbers may be expressed as a multiple of one of the numbers. Based on the value of the discriminator, specific rules for addition and/or subtraction are calculated and applied to obtain either an exact solution or a near exact solution that is within certain predefined tolerance ranges. The rules can be precomputed and stored for easy access. The computation of the discriminator is also optimized in a way that minimizes the computational complexity.

For purposes of simplification, in the following examples of PALNS representations, only two bases (B1, B2) and a single-digit will be considered. However, any number of bases and any number of digits may be used with these algorithms.

### Choice of Bases B1, B2

The derivation of a discriminator-based addition/subtraction algorithm in accordance with aspects described herein, begins with the selection of two bases B1, B2 to be used for the single-digit PALNS representation of two real numbers x and y.

Note that, for purposes of simplicity, the following examples in this section will focus on the choice of bases B1, B2 for an addition algorithm. However, the choice of bases for a subtraction algorithm follows the same logic.

The bases B1, B2 may be used to solve the following addition expression:

$$x + y = z , \qquad ( 1 )$$

wherein x, y and z are real numbers. The real numbers x, y and z may be represented by the bases B1, B2 in a two base, single digit PALNS as follows:

$$x = ( B 1 \hat{} a ) * ( B 2 \hat{} b ) , y = ( B 1 \hat{} c ) * ( B 2 \hat{} d ) and z = ( B 1 \hat{} e ) * ( B 2 \hat{} f ) , \qquad ( 2 )$$

wherein a, b, c, d, e and f are all integer exponents bounded by a reasonably small magnitude range. Accordingly, expression (1) may be rewritten as:

$$( B 1 \hat{} a ) * ( B 2 \hat{} b ) + ( B 1 \hat{} c ) * ( B 2 \hat{} d ) = ( B 1 \hat{} e ) * ( B 2 \hat{} f ) . \qquad ( 3 )$$

For purposes of deriving a discriminator based PALNS addition algorithm, it is important that the bases B1, B2 are selected to provide as many exact solutions or near exact solutions to the above expression (3) as reasonably possible.

Unfortunately, the number of exact solutions to expression (3) is generally limited, no matter what bases are chosen. For example, with the bases B1=2 and B2=3, there are only the following four solutions (or integer multiples of those four solutions) to the above expression (3):

$$If a = 0 , b = 0 , c = 0 , d = 0 , e = 1 and f = 0 , then ( 2 \hat{} 0 ) * ( 3 \hat{} 0 ) + ( 2 \hat{} 0 ) * ( 3 \hat{} 0 ) = ( 2 \hat{} 1 ) * ( 3 \hat{} 0 ) , or 1 + 1 = 2. Wherein x = 1 , y = 1 and y / x = 1. \qquad ( 4 a )$$

$$If a = 0 , b = 0 , c = 1 , d = 0 , e = 0 and f = 1 , then ( 2 \hat{} 0 ) * ( 3 \hat{} 0 ) + ( 2 \hat{} 1 ) * ( 3 \hat{} 0 ) = ( 2 \hat{} 0 ) * ( 3 \hat{} 1 ) , or 1 + 2 = 3. Wherein x = 1 , y = 2 and y / x = 2. \qquad ( 4 b )$$

$$If a = 0 , b = 0 , c = 0 , d = 1 , e = 2 and f = 0 , then ( 2 \hat{} 0 ) * ( 3 \hat{} 0 ) + ( 2 \hat{} 0 ) * ( 3 \hat{} 1 ) = ( 2 \hat{} 2 ) * ( 3 \hat{} 0 ) , or 1 + 3 = 4. Wherein x = 1 , y = 3 and y / x = 3. \qquad ( 4 c )$$

$$If a = 0 , b = 0 , c = 3 , d = 0 , e = 0 and f = 2 , then ( 2 \hat{} 0 ) * ( 3 \hat{} 0 ) + ( 2 \hat{} 3 ) * ( 3 \hat{} 0 ) = ( 2 \hat{} 0 ) * ( 3 \hat{} 2 ) , or 1 + 8 = 9. Wherein x = 1 , y = 8 and y / x = 8 . \qquad ( 4 d )$$

This means that trying to determine rules for solutions of the expression (3) using only exact solutions, may lead to rather large approximation errors for many pairs of real numbers x, y wherein the ratio of y/x falls between the ratios that lead to exact solutions. For example, if the ratio of y/x=5.5 (the midpoint between y/x=3 in expression (4c) and y/x=8 in expression (4d)), then any rule which approximates the ratio to 3 (based on rules for the exact solution of 4c) or 8 (based on rules for the exact solution of 4d) may have a significant error associated with it.

However, in many computer applications, exact solutions are not necessary. For example, in the emerging fields of artificial intelligence and machine learning applications, there is seldom a need for exact computations, especially in the inference phase. Accordingly, solutions based on almost exact solutions, within certain defined tolerance or error ranges, become a viable alternative.

Also, as will be explained in greater detail herein, even if the near solutions to the above expression (3) were restricted to relatively small tolerance ranges and relatively small sizes of the integers a, b, c, and d, then such restrictions would lead to a great deal more flexibility and number of solutions compared to exact solutions to the expression (3) above, especially if the bases B1, B2 are chosen carefully.

More specifically, expression (1) may be restated as follows:

x+y=z, where x, y, and z are of the set (B1\hat{ }a)*(B2\hat{ }b) and a and b are integers. (2)

We can normalize this equation by dividing both sides by z as follows:

$$X = x / z and Y = y / z , and X + Y = 1 \qquad ( 5 )$$

By doing this, normalized z becomes 1, wherein exponents e and f may be expressed as 0 and z can be expressed as (B1\hat{ }0)*(B2\hat{ }0)=1.

Accordingly, if we define ε as the allowable tolerance or error range, then the normalized near solution to expression (3) (which is: (B1\hat{ }a)*(B2\hat{ }b)+ (B1\hat{ }c)*(B2\hat{ }d)=(B1\hat{ }e)*(B2\hat{ }f)), can be expressed by the inequality of:

$$1 - ε \leq X + Y \geq 1 + ε \qquad ( 6 )$$

The above inequality (6) can be rewritten as:

$$1 - ε \leq ( B 1 \hat{} a ) * ( B 2 \hat{} b ) + ( B 1 \hat{} c ) * ( B 2 \hat{} d ) \geq 1 + ε \qquad ( 7 )$$

The above inequality (7) may have an infinite number of solutions. However, if restrictions are placed on the exponents a, b, c, d, then the solutions become bounded. None the less, if the bases B1, B2 are carefully chosen, then many solutions may exist even with small integer exponents and small tolerances ε.

By way of example, the following bases and restrictions may be applied to the above inequality (7):

$$B 1 = 1.609 and B 2 = 1.931$$

Exponents a, b, c, and d are restricted to three bits, which in two complement means they are restricted to the range of −4 to 3.

The value of ε is restricted to 0.02 (or plus or minus two percent of 1).

The above inequality (7) can therefore be rewritten as follows:

$$\vert ( 1.609 \hat{} a ) * ( 1.931 \hat{} b ) + ( 1.609 \hat{} c ) * ( 1.931 \hat{} d \vert \leq 0.02 for - 4 \leq a , b , c , d \leq 3 \qquad ( 8 )$$

The above inequality (8) has a total of 21 solutions as illustrated in the following table 4, wherein the fifth column from the left represents X+Y and the sixth (or last) column from the left represents the ratio of Y/X.

TABLE 4
The solutions of inequality (8)

| | | | | | Y/X= |
|---|---|---|---|---|---|
| | | | | X + Y = | (1.609^{a}1.931^{b})/ |
| | | | | 1.609^{a}1.931^{b} + | (1.609^{c}1.931^{d}) = |
| a | b | c | d | 1.609^{c}1.931^{d} = 1 ± 0.02 | 1.609^{c-a}1.931^{d-b} |
| −4 | −1 | 4 | −3 | 1.00811 | 12.047 |
| −4 | 0 | 1 | −1 | 0.982449 | 5.58468 |
| −4 | 1 | 2 | −2 | 0.98241 | 2.40985 |
| −3 | −2 | 4 | −3 | 0.995227 | 14.4581 |
| −3 | −1 | −3 | 2 | 1.01947 | 7.20024 |
| −3 | 0 | −2 | 1 | 0.985949 | 3.10698 |
| −3 | 1 | 0 | −1 | 0.981435 | 1.11713 |
| −2 | −3 | 4 | −3 | 0.984491 | 17.3515 |
| −2 | −2 | −3 | 2 | 0.998743 | 8.64118 |
| −2 | 0 | −1 | 0 | 1.00777 | 1.609 |
| −1 | −3 | −3 | 2 | 0.981468 | 10.3705 |
| −1 | −3 | 4 | −3 | 1.01716 | 10.784 |
| −1 | −2 | 1 | −1 | 0.999925 | 4.99913 |
| −1 | −1 | 2 | −2 | 1.01616 | 2.15718 |
| 0 | −4 | 4 | −3 | 1.00277 | 12.9422 |
| 0 | −2 | −2 | 1 | 1.01407 | 2.78122 |
| 1 | −4 | −3 | 2 | 1.01088 | 7.73516 |
| 1 | −2 | 3 | −3 | 1.01003 | 1.34069 |
| 2 | −4 | 1 | −1 | 1.01945 | 4.47498 |
| 2 | −3 | −1 | 0 | 0.981058 | 1.72854 |
| 3 | −4 | 2 | −2 | 0.993899 | 2.31744 |

Accordingly, with the proper choice of bases, such as B1=1.609 and B2=1.931, then even with rather sever restrictions, such as the exponents being within three bits and ε being less than or equal to 0.02 (or 2 percent), several solutions still exist. Moreover, with properly chosen bases, loosening up the restrictions even a little provides even more flexibility. For example, with bases B1=1.609 and B2=1.931, if the exponents a, b, c, d are allowed to grow to four bits (i.e., a numerical range of −8 to 7) and ε is kept at 2 percent, the number of solutions grows to 71. Also, by way of example, with bases B1=1.609 and B2=1.931, if ε is allowed to grow to 0.05 (or 5 percent) and the exponents are kept at three bits, then the number of solutions grows to 38.

As demonstrated above, a good choice of bases would be B1=1.609 and B2=1.931. As will be explained in greater detail herein, another reasonably good choice of bases would be B1=1.618 (the golden ratio) and B2=1.927 (one of the generalized golden ratios). Additionally, a reasonably good choice of bases would be B1=2 and B2=3.

### Derivation of the Discriminator K of the PALNS Addition Algorithm

It is important to note that in the determination of a discriminator K for the expression of x+y, wherein x and y are two positive real numbers, the designation of which real number is x (i.e., the first number in the expression) and which real number is y (i.e., the second number in the expression) is not important. However, the condition is imposed that, during the derivation of K, for any ratio of the two numbers, the larger of the two numbers is in the denominator. Importantly, this is done to avoid taking the log of a negative number.

In the following derivation of the discriminator K, the value of y, in the expression of x+y, is designated as greater than or equal to the value of x (i.e., y≥x). Accordingly, any ratio of the two numbers is expressed as y/x such that y/x≥1.

For the present examples herein, the bases of B1=1.618 and B2=1.927 will be used. The base of B1=1.618 is often referred to as the golden ratio and is the positive root of the equation x\hat{ }2−x−1=0. The base B2=1.927 is often referred to as one of the generalized golden ratios and is the positive root of x\hat{ }4−x\hat{ }3−x\hat{ }2−1=0.

The discriminator K is derived as follows:

Step 1: Select the bases B1, B2.

In the case of the present example, the bases have already been selected, wherein, B1=1.618 and B2=1.927.

Step 2: Based on the bases selected, calculate the log to the base B1 of B2 (herein designated as “R”). That is, a value of R=Log_{b1}B2 is calculated.

As will be discussed in greater detail herein, the value of R helps to enable a simple estimate of the ratio of y/x, wherein the value of y is set as being larger than or equal to the value of x (i.e., y/x≥1).

By way of the above example, if the bases are set at B1=1.618 and B2=1.927, then

R=log_{1.618} 1.927=1.36375.

Step 3: Estimate the R as a ratio of two positive integers, which may be expressed as R1/R2, wherein R1≥R2.

The integers R1, R2 may be, for example and without limitation, 8 bits long (which in two's complement would be a numerical range of −128 to 127), or may be 3 bits long (which in two's complement would be a numerical range of −4 to 3), or may be any size range in between, such as 7 bits (a numerical range of −64 to 63), 6 bits (a numerical range of −32 to 31), 5 bits (a numerical range of −16 to 15), or 4 bits (a numerical range of −8 to 7). The integer ranges of R1 and R2 may be set at higher ranges than 8 bits, but it may be rare that the accuracy of the estimate of R would require integer sizes of R1 and R2 to larger than 8 bits.

In the present example, R=1.36375 may be reasonably accurately approximated at 4/3=1.3333, wherein R1-4 and R2=3. The integer denominator R1 and integer numerator R2 of the approximated R would each only require 4 bits of computer memory to store and would estimate R to within an accuracy of about 3 percent.

If a more accurate estimate of R were required, then R may be approximated using two larger integers for R1 and R2 to attain any degree of accuracy required. However, the greater accuracy would correspondingly require more bit space. For example, R may be approximated at 27/20=1.350, wherein R1=27 and R2=20, which would estimate R to within an accuracy of about 1 percent and would require 6 bits of computer memory for both R1 and R2. Also by way of example, R may be approximated at 109/80=1.3625, which would require 8 bits of memory for both R1=109 and R2=80, but would be accurate to less than 0.1 percent.

Step 4: Based on the approximated value of r, estimate the log to the base B1 of the ratio of y/x. That is, estimate Log_{B1}(y/x).

The ratio of y/x in PALNS format may be expresses as ((B1\hat{ }c)*(B2\hat{ }d))/((B1\hat{ }a)*(B2\hat{ }b)), which can be simplified as: B1\hat{ }(c−a)*B2\hat{ }(d−b). For purposes of simplicity, the term “y/x” may also be designated as “W.”

Therefore: Log_{B1}(y/x)=Log_{B1}(W)=Log_{B1}(B1\hat{ }(c−a)*B2\hat{ }(d−b))=(c−a)+ (d−b)*Log_{B1}B2

Because R=Log_{B1}B2, the above expression can be written as:
Log_{B1}(B1\hat{ }(c−a)*B2\hat{ }(d−b))=(c−a)+ (d−b)*R, which can be approximated as:

$$\approx ( c - a ) + ( d - b ) * R 1 / R 2 = ( 1 / R 2 ) * ( ( R 2 * ( c - a ) + R 1 * ( d - b ) )$$

Step 5: Set the discriminator K to: K=R2*(c−a)+R1*(d−b).

Accordingly: Log_{B1}(y/x)=Log_{B1}(W)≈(1/R2)*K=K/R2

Therefore, W≈B1\hat{ }(K/R2).

Advantageously, because R1, R2, a, b, c and d are all integers, K is also an integer. Also advantageously, the above calculation of K and estimate of W is true for any set of bases B1, B2 and any set of integers a, b, c, d to be used in a PALNS dual base, single digit, addition algorithm.

In the present example with B1=1.618, B2=1.927, R1=4 and R2=3, then:

$$K = R 2 * ( c - a ) + R 1 * ( d - b ) = 3 * ( c - a ) + 4 * ( d - b ) , and$$

$$W \approx B 1 \hat{} ( K / R 2 ) = 1.618 \hat{} ( K / 3 ) .$$

By way of another example, if the bases had been selected to be B1=2 and B2-3, then using the same steps to derive K, one gets:

$$R = {log}_{2} 3 = 1.5 \; 85 \approx R 1 / R 2 = 8 / 5$$

$$K = R 2 * ( c - a ) + R 1 * ( d - b ) = 5 * ( c - a ) + 8 * ( d - b )$$

$$W = B 1 \hat{} ( K / R 2 ) = 2 \hat{} ( K / 5 )$$

By way of another example, if the bases had been selected to be B1=1.609 and B2=1.931 (both of which are only slightly different from B1 and B2 being the golden ratios of 1.618 and 1.92756 respectively), then using the same steps to derive K, one gets:

$$R = {log}_{1.609} 1.931 = 1.38 \; 356 \approx R 1 / R 2 = 7 / 5$$

$$K = R 2 * ( c - a ) + R 1 * ( d - b ) = 5 * ( c - a ) + 7 * ( d - b )$$

$$W \approx B 1 \hat{} ( K / R 2 ) = 1.609 \hat{} ( K / 5 )$$

### Derivation the Rules Based on K for the PALNS Addition Algorithm

Once K is determined for addition, the expression of x+y (wherein x and y are positive real numbers, and y is greater than or equal to x) can be modified as follows:

$$W = y / x \approx B 1 \hat{} ( K / R 2 ) .$$

$$y \approx x * B 1 \hat{} ( K / R 2 ) .$$

Therefore: x+y=x+x*B1\hat{ }(K/R2)=x*(1+B1\hat{ }(K/R2)).

The rules can then be determined for every integer value of K, based on the best approximation of 1+B1\hat{ }(K/R2) as (B1\hat{ }g(K))*(B2\hat{ }h(K)), wherein g(K) and h(K) are restricted to integers as a function on the value of K.

Accordingly, x+y≈x*(1+B1\hat{ }(K/R2))≈(B1\hat{ }a)*(B2\hat{ }b)*(B1\hat{ }g(K))*(B2\hat{ }h(K))=(B1\hat{ }(a+g(K))*(B2\hat{ }(b+h(K))=(B1\hat{ }e(K))*(B2\hat{ }f(K)).

Therefore, the rules become that for every integer value of K, the best approximation is calculated using, e(K)=a+g(K), and f(K)=b+h(K), wherein g(K) and h(K) are restricted to integers as a function of K. The rules may be pre-computed and stored in a look-up table based on the value of K.

Advantageously, because the exponents a, b, c, d, e(K), f(K), g(K) and h(K) are all integers, there is no need to utilize memory space for the location of a decimal point. Accordingly, the feature may significantly reduce the memory space required to perform complex mathematical functions.

For the present example, wherein:
a.

$$B 1 = 1.618 , B 2 = 1.927 ,$$

b. a, b, c and d are integers,
c. R≈R1/R2, wherein R1=4 and R2-3,
d.

$$K = 3 * ( c - a ) + 4 * ( d - b ) ,$$

e.

$$W \approx 1.609 \hat{} ( K / 3 ) .$$

The rules may be computed as shown in Table 5 as follows:

TABLE 5
Rules to estimate e and f for B1 = 1.618, B2 =
1.927, R1 = 4 and R2 = 3.

| K | Rule for (e, f) = (a + g(K), b + h(K)) |
|---|---|
| 0 | (a − 4, b + 4) |
| 1 | (a + 3, b − 1) |
| 2 | (a − 5, b + 5) |
| 3 | (a + 2, b) |
| 4 | (a − 6, b + 6) |
| 5 | (a − 3, b + 4) |
| 6 | (a + 4, b − 1) |
| 7 | (a + 7, b − 3) |
| 8 | (a − 5, b + 6) |
| 9 | (a − 2, b + 4) |
| 10 | (a + 1, b + 2) |
| 11 | (a + 4, b) |
| 12 | (a + 7, b − 2) |
| 13 | (a − 5, b + 7) |
| 14 | (a − 2, b + 5) |
| 15 | (a − 3, b + 6) |

Note: Table 5 does not display exact solutions, but near exact solutions. That is, the right column is satisfying the inequality of 1−ε≤X+Y≤1+ε (assuming x+y are normalized) for ε=0.02, just as in Table 4.

By way of another example, wherein:
a. B1=2, B2=3,
b. a, b, c and d are integers,
c. R≈R1/R2, wherein R1=8 and R2=5,
d.

$$K = 5 * ( c - a ) + 8 * ( d - b ) ,$$

e.

$$W \approx 2 \hat{} ( K / 5 ) .$$

The rules may be computed as shown in Table 6 as follows:

TABLE 6
Rules to estimate e and f for B1 = 2, B2 = 3, R1 = 8 and R2 = 5.

| K | Rule for (e, f) = (a + g(K), b + h(K)) |
|---|---|
| 1 | (a − 2, b + 2) |
| 2 | (a + 6, b − 3) |
| 3 | (a − 5, b + 4) |
| 4 | (a + 3, b − 1) |
| 5 | (a, b + 1) |
| 6 | (a − 3, b + 3) |
| 7 | (a + 5, b − 2) |
| 8 | (a + 2, b) |
| 9 | (a − 1, b + 2) |
| 10 | (a − 4, b + 4) |
| 11 | (a − 7, b + 6) |
| 12 | (a + 1, b + 1) |
| 13 | (a + 6, b − 2) |
| 14 | (a + 3, b) |
| 15 | (a, b + 2) |
| 16 | (a − 3, b + 4) |

Note: The same restrictions on X, Y and ε are applied in this Table 6 as in the previous Table 5.

More specifically, Table 6 does not display exact solutions, but near exact solutions. That is, the right column is satisfying the inequality of 1−ε≤X+Y≤1+ε (assuming x+y are normalized) for ε=0.02, just as in Table 4.

The value of K can be increased until it becomes so large (herein K-large) the associated ratio of W=y/x is considered so large that x is not considered significant compared to y.

Therefore, x+y≈y and, as a result, for any K>K-large, e(K)=c and f(K)=d.

The ratio of W wherein x is considered insignificant depends on the parameters of the application that the addition algorithm is being used in. W is often set at 10. However, W can be set at any other appropriate value, for example, 100, 1000 or others.

For the present example, wherein B1=1.618, B2=1.927, R1=4 and R2-3 if W is set at 10, then K-large would equal 15. That is, the rule for any integer value of K over 15 (i.e, from 16 on up), e(K)=c, and f(K)=d.

For the example, wherein B1=2, B2-3, R1=5 and R2=8 if W is set at 10, then K-large would equal 16. That is, the rule for any integer value of K over 16 (i.e, from 17 on up), e(K)=c, and f(K)=d.

Additionally, value of K can be decreased until it becomes substantially equal to 0. Therefore, the associated ratio of W=y/x is considered to be substantially equal to 1.

Therefore, x≈y, and x+y≈2y or 2x.

### Derivation of the Discriminator K of the PALNS Subtraction Algorithm

The determination of K for the subtraction expression of x−y, wherein x and y are positive real numbers, is similar to the previous determination of K for the addition expression x+y=K. However, the condition is imposed that the value of x (i.e., the first number in the expression) is greater than or equal to the value of y (i.e., the second number in the expression), such that x≥y. Additionally, any ratio of the two numbers is expressed as x/y such that x/y≥1. Importantly, this is done to avoid taking the log of a negative number.

As before, for the present examples herein, the bases of B1=1.618 and B2=1.927 will be used.

The discriminator K is derived as follows:

Step 1: Select the bases B1, B2.

In the case of the present example, the bases have already been selected, wherein, B1=1.618 and B2=1.927.

Step 2: Based on the bases selected, calculate the log to the base B1 of B2 (herein designated as “R”). That is, a value of R=Log_{B1}B2 is calculated.

As will be discussed in greater detail herein, the value of R helps to enable a simple estimate of the ratio of x/y, wherein x is set as being larger than or equal to y such that x/y≥1.

By way of the above example, if the bases are set at B1=1.618 and B2=1.927, then

$$R = {log}_{1.618} 1.927 = 1.36375$$

Step 3: Estimate the R as a ratio of two positive integers, which may be expressed as R1/R2, wherein R1≥R2.

The integers R1, R2 may be, for example and without limitation, 8 bits long (which in two's complement would be a numerical range of −128 to 127), or may be 3 bits long (which in two's complement would be a numerical range of −4 to 3), or may be any size range in between, such as 7 bits (a numerical range of −64 to 63), 6 bits (a numerical range of −32 to 31), 5 bits (a numerical range of −16 to 15), or 4 bits (a numerical range of −8 to 7). The integer ranges of R1 and R2 may be set at higher ranges than 8 bits, but it may be rare that the accuracy of the estimate of R would require integer sizes of R1 and R2 to larger than 8 bits.

In the present example, R=1.36375 may be reasonably accurately approximated at 4/3=1.3333, wherein R1=4 and R2-3. The integer denominator R1 and integer numerator R2 of the approximated R would each only require 4 bits of computer memory to store and would estimate R to within an accuracy of about 3 percent.

If a more accurate estimate of R were required, then R may be approximated using two larger integers for R1 and R2 to attain any degree of accuracy required.

Step 4: Based on the approximated value of R, estimate the log to the base B1 of the ratio of x/y. That is, estimate Log_{B1}(x/y).

The ratio of x/y in PALNS format may be expressed as
((B1\hat{ }a)*(B2\hat{ }b))/((B1\hat{ }c)*(B2\hat{ }d)), which can be simplified as: B1\hat{ }(a−c)*B2\hat{ }(b−d). For purposes of simplicity, term “x/y” may also be designated as “W.”

Therefore: Log_{B1}(x/y)=Log_{B1}(W)=Log_{B1}(B1\hat{ }(a−c)*B2\hat{ }(b−d))=(a−c)+ (b−d)*Log_{B1}B2 Because R=Log_{B1}B2, the above expression can be written as:
Log_{B1}(B1\hat{ }(a−c)*B2\hat{ }(b−d))=(a−c)+ (b−d)*R, which can be approximated as:

$$\approx ( a - c ) + ( b - d ) * R 1 / R 2 = ( 1 / R 2 ) * ( ( R 2 * ( a - c ) + R 1 * ( b - d ) )$$

Step 5: Set the discriminator K to: K=R2*(a−c)+R1*(b−d).

It is important to note that the above expression for K subtraction is the almost the same as the expression for K addition (i.e., K=R2*(c−a)+R1*(d−b)), except that the signs of a and c are swapped and the signs of b and d are swapped.

Accordingly: Log_{B1}(x/y)=Log_{B1}(W)≈(1/R2)*K=K/R2

Therefore, W≈B1\hat{ }(K/R2).

Advantageously, because R1, R2, a, b, c and d are all integers, K is also an integer. Also advantageously, the above calculation of K and estimate of W is true for any set of bases B1, B2 and any set of integers a, b, c, d to be used in a PALNS dual base, single digit, subtraction algorithm.

In the present example with B1=1.618, B2=1.927, R1-4 and R2=3, then:

$$K = R 2 * ( a - c ) + R 1 * ( b - d ) = 3 * ( a - c ) + 4 * ( b - d ) , and$$

$$W \approx B 1 \hat{} ( K / R 2 ) = 1.618 \hat{} ( K / 3 ) .$$

Please note the changes in the signs of a, b, c and d relative to the derivation of K for addition.

By way of another example, if the bases had been selected to be B1=2 and B2=3, then using the same steps to derive K, one gets:

$$R = {log}_{2} 3 = 1.585 \approx R 1 / R 2 = 8 / 5$$

$$K = R 2 * ( a - c ) + R 1 * ( b - d ) = 5 * ( a - c ) + 8 * ( b - d ) , and$$

$$W \approx B 1 \hat{} ( K / R 2 ) = 2 \hat{} ( K / 5 ) .$$

Please note the changes in the signs of a, b, c and d relative to the derivation of K for addition.

By way of another example, if the bases had been selected to be B1=1.609 and B2=1.931 (both of which are only slightly different from B1 and B2 being the golden ratios of 1.618 and 1.92756 respectively), then using the same steps to derive K, one gets:

$$R = {log}_{1.609} 1.931 = 1.38 \; 356 \approx R 1 / R 2 = 7 / 5$$

$$K = R 2 * ( a - c ) + R 1 * ( b - d ) = 5 * ( a - c ) + 7 * ( b - d )$$

$$W \approx B 1 \hat{} ( K / R 2 ) = 1.609 \hat{} ( K / 5 )$$

Again, please note the changes in the signs for a, b, c and d relative to the derivation of K for addition.

### Derivation the Rules Based on K for the PALNS Subtraction Algorithm

Once K is determined for subtraction, the expression of x−y (wherein x and y are positive real numbers, and x is greater than or equal to y) can be modified as follows:

$$W = x / y \approx B 1 \hat{} ( K / R 2 ) .$$

$$x \approx y * B 1 \hat{} ( K / R 2 ) .$$

Therefore: x−y≈y*B1\hat{ }(K/R2)−y=y*(B1\hat{ }(K/R2)−1).

The rules can then be determined for every integer value of K, based on the best approximation of B1\hat{ }(K/R2)−1 as (B1\hat{ }g(K))*(B2\hat{ }h(K)), wherein g(K) and h(K) are restricted to integers as a function of the value of K.

Accordingly, x−y≈y*(B1\hat{ }(K/R2)−1)≈(B1\hat{ }c)*(B2\hat{ }d)*(B1\hat{ }g(K))*(B2\hat{ }h(K))=(B1\hat{ }(c+g(K))*(B2\hat{ }(d+h(K))=(B1\hat{ }e(K))*(B2\hat{ }f(K)).

Therefore, the rules become that for every integer value of K, the best approximation is calculated as, e(K)=c+g(K), and f(K)=d+h(K), wherein g(K) and h(K) are restricted to integers as a function of K. The rules may be pre-computed and stored in a look-up table based on the value of K.

For the present example, wherein:
a.

$$B 1 = 1.618 , B 2 = 1.927 ,$$

b. a, b, c and d are integers,
c. R≈R1/R2, wherein R1-4 and R2-3,
d.

$$K = 3 * ( a - c ) + 4 * ( b - d ) ,$$

e.

$$W \approx 1.618 \hat{} ( K / 3 ) - 1 .$$

The rules for subtraction may be computed as shown in Table 7 as follows:

TABLE 7
Rules to estimate e and f for B1 = 1.618, B2 =
1.927, R1 = 4 and R2 = 3.

| | Rule for |
|---|---|
| | (e, f) = (c + g(K), |
| K | d + h(K)) |
| 0 | Result: set to 0 |
| 1 | (c − 5, d + 1) |
| 2 | (c − 2, d) |
| 3 | (c − 1, d) |
| 4 | (c − 3, d + 2) |
| 5 | (c − 1, d = 1) |
| 6 | (c − 1, d) |
| 7 | (c − 8, d + 7) |
| 8 | (c + 2, d) |
| 9 | (c − 3, d + 4) |
| 10 | (c + 7, d − 3) |
| 11 | (c + 6, d − 2) |
| 12 | (c + 5, d − 1) |
| 13 | (c, d + 3) |
| 14 | (c − 1, d + 4) |

Table 7 does not display exact solutions, but near exact solutions. That is, the right column is satisfying the inequality of 1−ε≤X+Y≤1+ε (assuming x+y are normalized) for ε=0.02, just as in Table 4.

If K>=15, then (e,f)=(c,d)

By way of another example, wherein:
a.

$$B 1 = 2 , B 2 = 3 ,$$

b. a, b, c and d are integers,
c. R≈R1/R2, wherein R1=8 and R2=5,
d.

$$K = 5 * ( a - c ) + 8 * ( b - d ) ,$$

and
e.

$$W \approx 2 \hat{} ( K / 5 ) - 1 .$$

The rules may be computed as shown in Table 8 as follows:

TABLE 8
Rules to estimate e and f for B1 = 2, B2 = 3, R1 = 8 and R2 = 5.

| K | Rule for (e, f) = (c + g(K), d + h(K)) |
|---|---|
| 1 | (c + 2, d − 3) |
| 2 | (c, d − 1) |
| 3 | (c − 1. d) |
| 4 | (c − 2, d + 1) |
| 5 | (c, d) |
| 6 | (c + 2, d − 1) |
| 7 | (c − 4, d + 3) |
| 8 | (c + 1, d) |
| 9 | (c − 5, d + 4) |
| 10 | (c, d + 1) |
| 11 | (c + 5, d − 2) |
| 12 | (c − 1, d + 2) |
| 13 | (c − 4, d + 4) |
| 14 | (c + 1, d + 1) |
| 15 | (c + 6, d − 2) |
| 16 | (c + 3, d) |

Table 8 does not display exact solutions, but near exact solutions. That is, the right column is satisfying the inequality of 1−ε≤X+Y≤1+ε (assuming x+y are normalized) for ε=0.02, just as in Table 4.

The value of K can be increased until it becomes so large (herein K-large) the associated ratio of W=x/y is considered so large that y is not considered significant compared to x.

Therefore, x−y≈x and, as a result, for any K>K-large, e(K)=c and f(K)=d.

The ratio of W wherein Y is considered insignificant depends on the parameters of the application that the addition algorithm is being used in. W is often set at 10. However, W can be set at any other appropriate value, for example, 100, 1000 or others.

For the present example, wherein B1=1.618, B2=1.927, R1=4 and R2=3 if W is set at 10, then K-large would equal 16. That is, the rule for any integer value of K over 16 (i.e., from 16+1 on up), e(K)=a, and f(K)=b.

For the example, wherein B1=2, B2-3, R1=5 and R2=8 if W is set at 10, then K-large would equal 14. That is, the rule for any integer value of K over 14 (i.e, from 14+1 on up), e(K)=a, and f(K)=b.

Additionally, value of K can be decreased until it becomes substantially equal to 0. Therefore, the associated ratio of W=y/x is considered to be substantially equal to 1.

Therefore, x≈y, and x−y≈0.

### Referring to the FIGS.

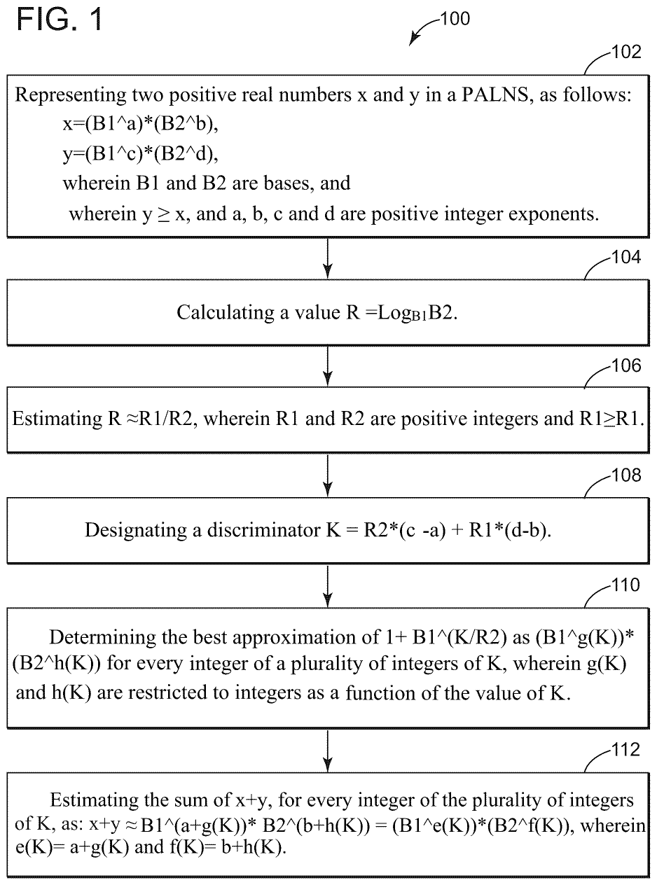

Referring to FIG. 1, an example is depicted of a computer-implemented method 100 of addition of real numbers represented in a parallel adaptive logarithmic number system (PALNS) according to aspects described herein. The PALNS represents real numbers in the format of a single digit and two bases.

The method may be implemented in a computer system, which includes a memory and one or more processors in electronic communication with the memory. An algorithm may be stored in the memory as a set of instructions for execution by the one or more processors. The algorithm may be programmed to perform the method.

The method may also be stored in a computer program product. The computer program product may include at least one non-transitory computer readable storage medium. The storage medium may store instructions, for execution by a processor, to perform the method.

At 102, two positive real numbers x and y are represented in a PALNS, as follows:
a. x=(B1\hat{ }a)*(B2\hat{ }b),
b. y=(B1\hat{ }c)*(B2\hat{ }d),
c. wherein B1 and B2 are bases, and
d. wherein y≥x, and a, b, c and d are positive integer exponents.

It is important to note that in the sum term x+y, the order is immaterial. What is important is that the larger number (which will be designated herein as y) be in the numerator of any ratio of the two numbers (i.e., y/x, herein designated as “W”) to ensure that the ratio W=y/x is ≥1.

At 104, a value of R is calculated as Log_{B1}B2. R helps to enable a simple estimate of W.

At 106, R is approximated as R1/R2, wherein R1 and R2 are positive integers, and wherein R1≥R2. R1 and R2 can be any size needed to achieve any accuracy required. For example, R1 and R2 may be 8 bits long, 7 bits long, 6 bits long, 5 bits long, 4 bits long, 3 bits long or smaller. R1 and R2 may also be larger than 8 bits, but this level of required accuracy may be rare.

At 108, A discriminator K is designated as (R2*(c−a)+R1*(d−b).

More specifically, once R, R1 and R2 are determined, an estimate of the log to the base B1 of the ratio W=y/x may be approximated and expanded as follows:
e. Log_{B1}(y/x)=Log_{B1}(W)=Log_{B1}(B1\hat{ }(c−a)*B2\hat{ }(d−b))=(c−a)+ (d−b)*Log_{B1}B2.

Because R=Log_{B1}B2, the above expression can be written as:
f. Log_{B1}(B1\hat{ }(c−a)*B2\hat{ }(d−b))=(c−a)+ (d−b)*R, which can be approximated as:

$$g . \approx ( c - a ) + ( d - b ) * R 1 / R 2 = ( 1 / R 2 ) * ( ( R 2 * ( c - a ) + R 1 * ( d - b ) ) .$$

From the above expression, K can be designated as R2*(c−a)+R1*(d−b).

Accordingly: Log_{B1}(y/x)=Log_{B1}(W)≈(1/R2)*K=K/R2.

Therefore, W≈B1\hat{ }(K/R2).

Advantageously, because R1, R2, a, b, c and d are all integers, K is also an integer. Also advantageously, the above calculation of K and estimate of W is true for any set of bases B1, B2 and any set of integers a, b, c, d to be used in a PALNS dual base, single digit, addition algorithm.

At 110, the best approximation of 1+B1\hat{ }(K/R2) as (B1\hat{ }g(K))*(B2\hat{ }h(K)) may be determined for every integer of a plurality of integers of K, wherein g(K) and h(K) are restricted to integers as a function of the value of K.

More specifically, once K is determined for addition, the expression of x+y (wherein x and y are positive real numbers, and y is greater than or equal to x) can be modified as follows:

$$W = y / x \approx B 1 \hat{} ( K / R 2 ) .$$

$$y \approx x * B 1 \hat{} ( K / R 2 ) .$$

Therefore: x+y=x+x*B1\hat{ }(K/R2)=x*(1+B1\hat{ }(K/R2)).

Therefore rules can then be determined for every integer value of K, based on the best approximation of 1+B1\hat{ }(K/R2) as (B1\hat{ }g(K))*(B2\hat{ }h(K)), wherein g(K) and h(K) are restricted to integers as a function on the value of K. For example, the best approximation of 1+B1\hat{ }(K/R2) may be determined to be within plus or minus 10 percent, 5 percent, 3 percent, 1 percent or less of the true value of 1+B1\hat{ }(K/R2), for every integer of the plurality of integers of K.

At 112, the sum of x+y may be approximated for every integer of the plurality of integers of K, as: x+y≈B1\hat{ }(a+g(K))*B2\hat{ }(b+h(K))=(B1\hat{ }e(K))*(B2\hat{ }f(K)), wherein e(K)=a+g(K) and f(K)=b+h(K). For example, the sum may be approximated to be within plus or minus 10 percent, 5 percent, 3 percent, 1 percent of less of the true value of x+y, for every integer of the plurality of integers K, as x+y≈B1\hat{ }(a+g(K))*B2\hat{ }(b+h(K)).

Moreover, K may be determined from K=1 to at least K=K-large, and wherein, for K=K-large, the value of y/x=W=B1\hat{ }(K-large/R2)≥10. At that point, the size of x relative to y is considered insignificant and the sum of x+y, for every integer value of K above K-large is set equal to the value of y. Also, by way of example, the point where K=K-large may be designated to be the point where W≥100 or where W≥1000 or higher.

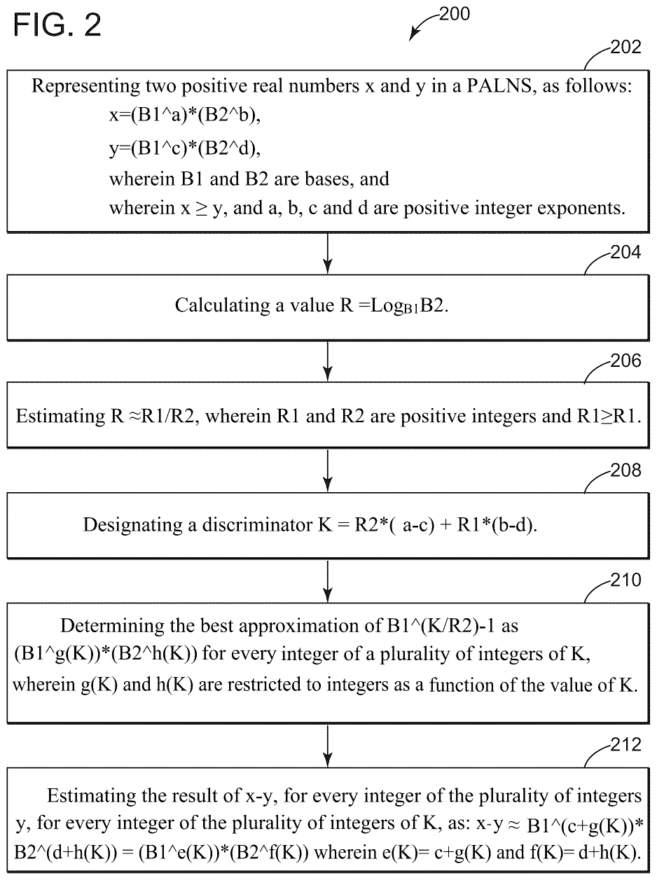

Referring to FIG. 2, an example is depicted of a computer-implemented method 200 of subtraction of real numbers represented in a parallel adaptive logarithmic number system (PALNS) according to aspects described herein. The PALNS represents real numbers in the format of a single digit and two bases.

The method may be implemented in a computer system, which includes a memory and one or more processors in electronic communication with the memory. An algorithm may be stored in the memory as a set of instructions for execution by the one or more processors. The algorithm may be programmed to perform the method.

The method may also be stored in a computer program product. The computer program product may include at least one non-transitory computer readable storage medium. The storage medium may store instructions, for execution by a processor, to perform the method.

At 202, two positive real numbers x and y are represented in a PALNS, as follows:
h.

$$x = ( B 1 \hat{} a ) * ( B 2 \hat{} b ) ,$$

i.

$$y = ( B 1 \hat{} c ) * ( B 2 \hat{} d ) ,$$

j. wherein B1 and B2 are bases, and
k. wherein x≥y, and a, b, c and d are positive integer exponents.

It is important to note that in the sum term x−y, the term x is set greater than y to avoid having to deal with the log of a negative number. What is also important is that the larger number (which is designated herein as x) be in the numerator of any ratio of the two numbers (i.e., x/y, herein designated as “W”) to ensure that the ratio W=x/y is ≥1.

At 204, a value of R is calculated as Log_{B1}B2. R helps to enable a simple estimate of W.

At 206, R is approximated as R1/R2, wherein R1 and R2 are positive integers, and wherein R1≥R2. R1 and R2 can be any size needed to achieve any accuracy required. For example, R1 and R2 may be 8 bits long, 7 bits long, 6 bits long, 5 bits long, 4 bits long, 3 bits long or smaller. R1 and R2 may also be larger than 8 bits, but this level of required accuracy may be rare.

At 208, A discriminator K is designated as (R2*(a−c)+R1*(b−d).

More specifically, once R, R1 and R2 are determined, an estimate of the log to the base B1 of the ratio W=x/y may be approximated and expanded as follows:

$${Log}_{B 1} ( x / y ) = {Log}_{B 1} ( W ) = {Log}_{B 1} ( B 1 \hat{} ( a - c ) * B 2 \hat{} ( b - d ) ) = ( a - c ) + ( b - d ) * {Log}_{B 1} B 2. \qquad 1$$

Because R=Log_{B1}B2, the above expression can be written as:
m. Log_{B1}(B1\hat{ }(a−c)*B2\hat{ }(b−d))=(a−c)+ (b−d)*R, which can be approximated as:

$$n . \approx ( a - c ) + ( b - d ) * R 1 / R 2 = ( 1 / R 2 ) * ( ( R 2 * ( a - c ) + R 1 * ( b - d ) ) .$$

From the above expression, K can be designated as R2*(c−a)+R1*(b−d).

Accordingly: Log_{B1}(x/y)=Log_{B1}(W)≈(1/R2)*K=K/R2.

Therefore, W≈B1\hat{ }(K/R2).

Advantageously, because R1, R2, a, b, c and d are all integers, K is also an integer. Also advantageously, the above calculation of K and estimate of W is true for any set of bases B1, B2 and any set of integers a, b, c, d to be used in a PALNS dual base, single digit, addition algorithm.

At 210, the best approximation of B1\hat{ }(K/R2)−1 as (B1\hat{ }g(K))*(B2\hat{ }h(K)) may be determined for every integer of a plurality of integers of K, wherein g(K) and h(K) are restricted to integers as a function of the value of K.

More specifically, once K is determined for addition, the expression of x−y (wherein x and y are positive real numbers, and x is greater than or equal to y) can be modified as follows:

W=x/y≈B1\hat{ }(K/R2).

$$x \approx y * B 1 \hat{} ( K / R 2 ) .$$

Therefore: x−y≈y*B1\hat{ }(K/R2)−y=y*(B1\hat{ }(K/R2)−1).

Therefore rules can then be determined for every integer value of K, based on the best approximation of B1\hat{ }(K/R2)−1 as (B1\hat{ }g(K))*(B2\hat{ }h(K)), wherein g(K) and h(K) are restricted to integers as a function on the value of K. For example, the best approximation of B1\hat{ }(K/R2)−1 may be determined to be within plus or minus 10 percent, 5 percent, 3 percent, 1 percent or less of the true value of B1\hat{ }(K/R1)−1, for every integer of the plurality of integers of K.

At 212, the result of x−y may be approximated for every integer of the plurality of integers of K, as: x−y≈B1\hat{ }(c+g(K))*B2\hat{ }(d+h(K))=(B1\hat{ }e(K))*(B2\hat{ }f(K)), wherein e(K)=c+g(K) and f(K)=d+h(K). For example, the sum may be approximated to be within plus or minus 10 percent, 5 percent, 3 percent, 1 percent of less of the true value of x−y, for every integer of the plurality of integers K, as x−y≈B1\hat{ }(c+g(K))*B2\hat{ }(d+h(K)).

Moreover, K may be determined from K=1 to at least K=K-large, and wherein, for K=K-large, the value of x/y=W=B1\hat{ }(K-large/R1)≥10. At that point, the size of y relative to x is considered insignificant and the sum of x−y, for every integer value of K above K-large is set equal to the value of x. Also, by way of example, the point where K=K-large may be designated to be the point where W≥100 or the point where W≥1000 or higher.

### Improvements in the Field of Computer Technology

Use of the improved parallel adaptive logarithmic number systems (PALSN) addition and/or subtraction algorithms in a computer system leads to a substantial reduction in memory requirements compared to when using a classical logarithmic number system (LNS) addition and/or subtraction algorithms. Such a reduction in memory requirements leads to less power required, and more speed attainable, when running algorithms on a computer, especially when intensive and complex mathematical computations are involved. As discussed earlier herein, some, but not all, of the reasons for this advantageous reduction in memory requirements are as follows:
In the PALNS representations of numbers disclosed herein, the exponents, aj that each of the bases Bj are raised to may all be non-negative integers, which may significantly reduce the amount of storage space required to store a real number in a computer's memory.
When setting the discriminator K, because R1, R2, a, b, c and d are all integers, K is also an integer.
Because the exponents a, b, c, d, e(K), f(K), g(K) and h(K) are all integers, there is no need to utilize memory space for the location of a decimal point.

The reduction in memory requirements also leads to major reductions in the size of look up tables (LUTs) required to perform addition and subtraction for a PALNS algorithm based system compared to a classical LNS algorithm base system. As mentioned earlier herein, the size of the LUTs is one of the major technical issues facing addition and subtraction using classical LNS algorithms. The following Table 9 provides a comparison between the sizes of LUTs used for addition and subtraction using LNS algorithms vs. the sizes of LUTs used for addition and subtraction using the improved PALNS algorithms.

TABLE 9
Comparison of size of LUTs between LNS adders and PALNS adders.

| | LUT used in the existing | LUT used in the improved |
|---|---|---|
| | logarithmic (LNS) adders | PALNS adders (measured in |
| Size of the adders (in bits) | (measured in bytes) | bytes) |
| 4 bit adder | 16 | 4 |
| 6 bit adder | 64 | 8 |
| 8 bit adder | 256 | 16 |
| 10 bit adder | 1024 | 32 |
| 12 bit adder | 4096 | 64 |

The advantageous size reduction increases with the size of the added. For 8, 10 and 12 bit adders, it is more than an order of magnitude advantage. This represents a major technical improvement in the field of computer technology.

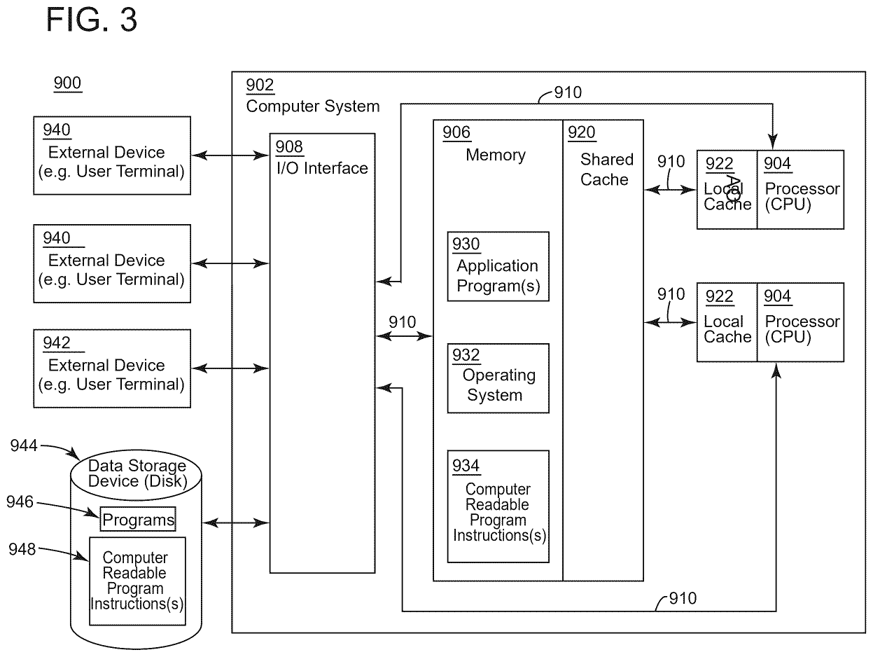

Referring to FIG. 3, a computing environment 900 useable to perform the process and/or method of this invention is disclosed. The computing environment includes, for instance, a computer system 902 shown, e.g., in the form of a general-purpose computing device. Computer system 902 may include, but is not limited to, one or more processors or processing units 904 (e.g., central processing units (CPUs)), a memory 906 (a.k.a., system memory, main memory, main storage, central storage or storage, as examples), and one or more input/output (I/O) interfaces 908, coupled to one another via one or more buses and/or other connections 910.

Bus 910 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 906 may include, for instance, a cache 920, such as a shared cache, which may be coupled to local caches 922 of processors 904. Further, memory 906 may include one or more programs or applications 930, an operating system 932, and one or more computer readable program instructions 934. Computer readable program instructions 934 may be configured to carry out functions of embodiments of aspects of the invention.

Computer system 902 may also communicate via, e.g., I/O interfaces 908 with one or more external devices 940, one or more network interfaces 942, and/or one or more data storage devices 944. Example external devices include a user terminal, a tape drive, a pointing device, a display, etc. Network interface 942 enables computer system 902 to communicate with one or more networks, such as a local area network (LAN), a general wide area network (WAN), and/or a public network (e.g., the Internet), providing communication with other computer devices or systems. For example, the system may be connected to a personal computer, tablet device or smart phone to communicate the assigned or unassigned status of mobile objects to user via a graphical user interface.

Data storage device 944 may store one or more programs 946, one or more computer readable program instructions 948, and/or data, etc. The computer readable program instructions may be configured to carry out functions of embodiments of aspects of the invention.

Computer system 902 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 902. Examples, include, but are not limited to: microcode, device drivers, redundant processing units, external disk drive arrays, RAID systems, tape drives, and data archival storage systems, etc.

Computer system 902 may be operational with numerous other general purposes or special purpose computing system environments or configurations. Examples of well-known computing systems, environments, and/or configurations that may be suitable for use with computer system 902 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

One or more of the processors and/or other aspects of the computer system or computing environment may be remote from the mobile object. Further, in one particular example, a processor, such as processor 904, may execute, in accordance with one or more aspects of the present invention, one or more machine learning engines and/or other engines to provide, based on training and learning, an optimal travel route or path for mobile object. These engines may be stored in memory, including main memory and/or one or more caches, and/or external storage, and may be executed on one or more processors. Many variations exist.

One or more aspects of the present invention are inextricably tied to computer technology and/or to the improvement of a technical field.

One or more aspects may relate to cloud computing. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (Saas): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages such as Angular, HTML, CSS, .NET Framework, C# and Microsoft SQL Server, and including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different types of unmanned aerial vehicles may be used, as well as other types of neural networks and/or evolutionary algorithms. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A computer-implemented method of addition of real numbers represented in a parallel adaptive logarithmic number system (PALNS), the method comprising:
representing two positive real numbers x and y in a PALNS, as follows:
$$x = ( B 1 \hat{} a ) * ( B 2 \hat{} b ) ,$$
$$y = ( B 1 \hat{} c ) * ( B 2 \hat{} d ) ,$$
wherein B1 and B2 are bases, and
wherein y≥x, and a, b, c and d are positive integer exponents;
calculating a value R=Log_{B1}B2;
estimating R≈R1/R2, wherein R1 and R2 are positive integers and R1≥R2;
designating a discriminator K=(R2*(c−a)+R1*(d−b);
determining the best approximation of 1+B1\hat{ }(K/R2) as (B1\hat{ }g(K))*(B2\hat{ }h(K)) for every integer of a plurality of integers of K, wherein g(K) and h(K) are restricted to integers as a function of the value of K; and
estimating the sum of x+y, for every integer of the plurality of integers of K, as: x+y≈B1\hat{ }(a+g(K))*B2\hat{ }(b+h(K))=(B1\hat{ }e(K))*(B2\hat{ }f(K)), wherein e(K)=a+g(K) and f(K)=b+h(K).

2. The computer implemented method of claim 1, wherein estimating the sum of x+y further comprises:
estimating the sum of x+y to within plus or minus 5 percent of the true value of x+y, for every integer of the plurality of integers K, as x+y≈B1\hat{ }(a+g(K))*B2\hat{ }(b+h(K)).

3. The computer implemented method of claim 1, wherein determining the best approximation of 1+B1\hat{ }(K/R2) further comprises:
determining the best approximation of 1+B1\hat{ }(K/R2) to within plus or minus 5 percent of the true value of 1+B1\hat{ }(K/R2), for every integer of the plurality of integers of K.

4. The computer implemented method of claim 1, wherein estimating R≈R1/R2 further comprises: R1 and R2 having a size of 8 bits or less.

5. The computer implemented method of claim 1, wherein estimating R≈R1/R2 further comprises: R1 and R2 having a size of 5 bits or less.

6. The computer implemented method of claim 1, further comprising:
determining the best approximation of 1+B1\hat{ }(K/R2) as (B1\hat{ }g(K))*(B2\hat{ }h(K)) for every integer of a plurality of integers of K, wherein the plurality of integers of K range from K=1 to at least K=K-large, and wherein, for K=K-large, the value of B1\hat{ }(K-large/R2)≥10; and
estimating the sum of x+y, for every integer value of K above K-large as equal to the value of y.

7. The computer implemented method of claim 6, wherein, for K=K-large, the value of
$$B 1 \hat{} ( K - large / R 2 ) \geq 100 .$$

8. A computer-implemented method of subtraction of real numbers represented in a parallel adaptive logarithmic number system (PALNS), the method comprising:
representing two positive real numbers x and y in a PALNS, as follows:
$$x = ( B 1 \hat{} a ) * ( B 2 \hat{} b ) ,$$
$$y = ( B 1 \hat{} c ) * ( B 2 \hat{} d ) ,$$
wherein B1 and B2 are bases, and
wherein x≥y, and a, b, c and d are positive integer exponents;
calculating a value R=Log_{B1}B2;
estimating R≈R1/R2, wherein R1 and R2 are positive integers and R1≥R2;
designating a discriminator K=(R2*(a−c)+R1*(b−d);
determining the best approximation of B1\hat{ }(K/R2)−1 as (B1\hat{ }g(K))*(B2\hat{ }h(K)) for every integer of a plurality of integers of K, wherein g(K) and h(K) are restricted to integers as a function of the value of K; and
estimating the result of x−y, for every integer of the plurality of integers of K, as: x−y≈B1\hat{ }(c+g(K))*B2\hat{ }(d+h(K))=(B1\hat{ }e(K))*(B2\hat{ }f(K)) wherein e(K)=c+g(K) and f(K)=d+h(K).

9. The computer implemented method of claim 8, wherein estimating the result of x−y further comprises:
estimating the result of x−y to within plus or minus 5 percent of the true value of x−y, for every integer of the plurality of integers K, as x−y≈B1\hat{ }(c+g(K))*B2\hat{ }(d+h(K)).

10. The computer implemented method of claim 8, wherein determining the best approximation of B1\hat{ }(K/R2)−1 further comprises:
determining the best approximation of B1\hat{ }(K/R2)−1 to within plus or minus 5 percent of the true value of B1\hat{ }(K/R2)−1, for every integer of the plurality of integers of K.

11. The computer implemented method of claim 8, wherein estimating R≈R1/R2 further comprises: R1 and R2 having a size of 8 bits or less.

12. The computer implemented method of claim 8, wherein estimating R≈R1/R2 further comprises: R1 and R2 having a size of 5 bits or less.

13. The computer implanted method of claim 8, further comprising:
determining the best approximation of B1\hat{ }(K/R2)−1 as (B1\hat{ }g(K))*(B2\hat{ }h(K)) for every integer of a plurality of integers of K, wherein the plurality of integers of K range from K=1 to at least K=K-large, and wherein, for K=K-large, the value of B1\hat{ }(K-large/R2)≥10; and
estimating the result of x−y, for every integer value of K above K-large as equal to the value of x.

14. The computer implemented method of claim 13, wherein, for K=K-large, the value of B1\hat{ }(K-large/R2)≥100.

15. A computer system comprising:
a memory;
a processor in communication with the memory; and
an algorithm stored in the memory as a set of instructions for execution by the processor, the algorithm programmed to perform a method of addition of real numbers represented in a parallel adaptive logarithmic number system (PALNS), the method comprising:
representing two positive real numbers x and y in a PALNS, as follows:
x=(B1\hat{ }a)*(B2\hat{ }b),
y=(B1\hat{ }c)*(B2\hat{ }d),
wherein B1 and B2 are bases, and
wherein y≥x, and a, b, c and d are positive integer exponents,
calculating a value R=Log_{B1}B2,
estimating R≈R1/R2, wherein R1 and R2 are positive integers and R1≥R1,
designating a discriminator K=(R2*(c−a)+R1*(d−b),
determining the best approximation of 1+B1\hat{ }(K/R2) as (B1\hat{ }g(K))*(B2\hat{ }h(K)) for every integer of a plurality of integers of K, wherein a (K) and b (K) are restricted to integers as a function of the value of K, and
estimating the sum of x+y, for every integer of the plurality of integers of K, as: x+y≈B1\hat{ }(a+g(K))*B2\hat{ }(b+h(K))=(B1\hat{ }e(K))*(B2\hat{ }f(K)), wherein e(K)=a+g(K) and f(K)=b+h(K).

16. The computer system of claim 15, wherein estimating the sum of x+y further comprises:
estimating the sum of x+y to within plus or minus 5 percent of the true value of x+y, for every integer of the plurality of integers K, as x+y≈B1\hat{ }(a+g(K))*B2\hat{ }(b+h(K)).

17. The computer system claim 15, wherein determining the best approximation of 1+B1\hat{ }(K/R2) further comprises:
determining the best approximation of 1+B1\hat{ }(K/R2) to within plus or minus 5 percent of the true value of 1+B1\hat{ }(K/R2), for every integer of the plurality of integers of K.

18. The computer system claim 15, wherein estimating R≈R1/R2 further comprises: R1 and R2 having a size of 8 bits or less.

19. The computer system of claim 15, wherein estimating R≈R1/R2 further comprises: R1 and R2 having a size of 5 bits or less.

20. The computer system of claim 15, further comprising:
determining the best approximation of 1+B1\hat{ }(K/R2) as (B1\hat{ }g(K))*(B2\hat{ }h(K)) for every integer of a plurality of integers of K, wherein the plurality of integers of K range from K=1 to at least K=K-large, and wherein, for K=K-large, the value of B1\hat{ }(K-large/R2)≥10; and
estimating the sum of x+y, for every integer value of K above K-large as equal to the value of y.
